(19) United States
(12) Patent Application Publication
(10) Pub. No.: US 2014/0319096 A1
(43) Pub. Date: Oct. 30, 2014

(54) BOTTLE HAVING A SHRINK-FITTED PLASTIC FILM AND METHOD FOR PRODUCING SAME

(71) Applicant: Henkel AG & Co. KGaA, Duesseldorf (DE)

(72) Inventor: Andreas Nover, Grevenbroich (DE)

(21) Appl. No.: 14/324,304

(22) Filed: Jul. 7, 2014

Related U.S. Application Data
(63) Continuation of application No. PCT/EP2012/064050, filed on Jul. 18, 2012.

(30) Foreign Application Priority Data
Jan. 9, 2012 (DE) 10 2012 200 187.5

(51) Int. Cl. B65D 23/10; B23K 26/38; B29C 65/66

(52) U.S. Cl. CPC B65D 23/102; B29C 65/66; B23K 26/38
USPC 215/384; 156/86

(57) ABSTRACT

The invention relates to a method for producing a bottle having a sheath made of a shrinkable plastic film, the bottle comprising, on the circumferential surface thereof, at least one grip recess or handle opening projecting into the interior of the bottle, comprising the following steps: producing a tube from the shrinkable plastic film; drawing the tube onto the bottle; shrinking the plastic film onto the bottle; laser-cutting the area of the shrinkable plastic film which covers the grip recess or handle opening of the bottle; and sucking away the cut-out area by means of a fan.

### FIELD OF THE INVENTION

The present invention generally relates to a bottle having a sheath made of a plastic film shrink-fitted onto the circumferential surface of the bottle, wherein the bottle comprises on the circumferential surface thereof at least one recess or opening projecting into the interior of the bottle and wherein the area of the shrink-fitted plastic film which encloses the recess or opening of the bottle is produced by means of laser-cutting, as well as to a method for producing the bottle.

### BACKGROUND OF THE INVENTION

Bottles are well known in the prior art as containers for flowable or pourable products. According to the intended use or size of the bottle, it may be useful to provide a bottle with a hand-grip or a grip recess in order to facilitate handling for the user.

At the same time, as well as ease of handling, the requirements relating to the esthetic impression made by a bottle on a user are also increasing. So-called shrink films are increasingly being employed here, which are usually placed around the entire body of the bottle and which, owing to the complete-surface printability of the film, allow a graphic design to be provided on the entire body of the bottle.

One problem in connection with this consists in the fact that the grip recesses or hand-grips in a bottle, which are wanted for ergonomic reasons, are not covered by the shrink films, which are desirable for reasons of design.

The invention is therefore based on the technical problem of providing a bottle having a usable hand-grip or grip recess, which bottle is fitted with a shrink film.

Furthermore, other desirable features and characteristics of the present invention will become apparent from the subsequent detailed description of the invention and the appended claims, taken in conjunction with the accompanying drawings and this background of the invention.

### BRIEF SUMMARY OF THE INVENTION

A method for producing a bottle having a sheath made of a shrinkable plastic film, wherein the bottle comprises on the circumferential surface thereof at least one grip recess or handle opening projecting into the interior of the bottle, comprising the following steps: producing a tube from the shrinkable plastic film, drawing the tube onto the bottle, shrink-fitting the plastic film onto the bottle, laser-cutting the area of the shrinkable plastic film which covers the grip recess or handle opening of the bottle, sucking away the cut-out area by means of a blower.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

The method for producing a bottle having a sheath made of a shrinkable plastic film, wherein the bottle comprises on the circumferential surface thereof at least one grip recess or handle opening projecting into the interior of the bottle, comprises the following steps:
a. producing a tube from the shrinkable plastic film,
b. drawing the tube onto the bottle,
c. shrink-fitting the plastic film onto the bottle,
d. laser-cutting the area of the shrinkable plastic film which covers the grip recess or handle opening of the bottle,
e. sucking away the cut-out area by means of a blower.

### (a) Tube Production

The production of a tube from a shrinkable plastic film is known in principle from the prior art. In this process, a printed, thermoformable plastic film is bonded or welded along its longitudinal seam to form a tube and is then packed as a roll on a core or flat-packed.

(b) Drawing of the Tube onto the Bottle

For drawing on the tube made of shrinkable plastic film, the tube is first separated according to the individual repeat length or according to pre-fabricated, flat blanks, to be drawn over the bottle subsequently by the methods known from the prior art.

(c) Shrink-Fitting of the Tube onto the Bottle

The tube made of shrinkable plastic film, which has been drawn onto the bottle, is then thermally heated and, as a result, conforms to the contour of the bottle until the tube fits closely to the contour of the bottle.

### (d) Laser-Cutting

Finally, the grip recess area that is covered by the plastic film is cut out by means of laser-cutting. The laying open of the hand-grip recess is preferably performed using a 60 W CO2 laser, which allows smooth cut surfaces to be produced in the plastic film without damaging the bottle walls beneath. The cut-out section is sucked away from the bottle using a vacuum blower.

### (e) Blower

The sucking away of the cut-out section can be achieved e.g. by means of suitable compressed air injectors or hydraulic pumps, which take the form of a vacuum blower. The vacuum blowers are configured such that the cut-out section of the plastic film can be sucked away from the bottle on completion of the laser-cutting.

### Bottle

A bottle within the meaning of this application is a closable, substantially dimensionally stable container for accommodating a flowable or pourable product, which container comprises a filling volume formed by a base and a body, wherein the filling volume can be filled or emptied through an opening formed through the body in the shape of a bottle neck tapering towards the opening, wherein the cross-section of the base is greater than the cross-section of the opening.

The bottle has in particular a filling volume of between 50 ml and 5,000 ml, preferably between 250 ml and 3,000 ml and particularly preferably between 500 ml and 2,500 ml.

The bottle is preferably molded from a plastic. However, it is also possible to make the bottle from another material, such as e.g. glass, cardboard, board, metal, ceramics or any combinations thereof, particularly if plastic is incompatible with the product with which the bottle is to be filled.

The wall thickness of the bottle is selected such that the bottle is substantially dimensionally stable. In one embodiment of the bottle, the walls or the circumferential surface can be capable of elastic deformation in order to exert a pressure on the products that are present in the bottle, thereby assisting the delivery of product from the container.

In another advantageous embodiment of the invention, the bottle can also take the form of a dual- or multi-chamber container. Advantageously, each chamber then contains a different product. For instance, it is possible to store e.g. a liquid product in one chamber and a solid, in particular powdered or granular, product in another chamber. Other examples of product combinations found in a dual-chamber bottle can be taken from the following table.

| | | | Solid | Solid | Solid |
|---|---|---|---|---|---|
| Liquid | Liquid | Liquid | product | product | product |
| Washing | Washing | Washing | Washing | Washing | Washing |
| agent A | agent B | agent A | agent B | agent A | agent B |
| Washing | Fabric | Fabric | Washing | | |
| agent | softener | softener | agent | | |
| Washing | Bleach | Bleach | Washing | | |
| agent | | | agent | | |
| Dish- | Dish- | Rinse aid | Dishwashing | | |
| washing | washing | | agent | | |
| agent A | agent B | | | | |
| Dish- | Bleach | Bleach | Dishwashing | | |
| washing | | | agent | | |
| agent | | | | | |
| Cleaning | Cleaning | Washing | Fabric | | |
| agent A | agent B | agent | softener | | |

Advantageously, the bottle can be produced in one piece from an appropriate preform in a blow-molding process. The handle opening or grip recess is molded integrally out of or into the body of the bottle in the blow-molding process. As a result, the bottle with handle opening or grip recess can be formed in just one production step.

### Handle Opening

A handle opening within the meaning of this application is a carrying device shaped as part of the bottle, which allows the user's hand to grip around it, at least partially, to facilitate transport and handling of the bottle, wherein the handle opening forms a chamber for accommodating product, said chamber communicating with the body of the bottle. The handle opening can in particular be bow-shaped. In the case of a bow-shaped handle opening, two connecting openings are formed between body and chamber.

### Grip Recess

A hand-grip within the meaning of this application is a carrying device shaped as part of the bottle, which allows the user's hand to grip into it, at least partially, to facilitate transport and handling of the bottle.

### Shrink Film

Shrink film is understood to be a thermoplastic film that has been pretreated by stretching, which shrinks or contracts when exposed to heat.

The shrink film and the bottle are configured here in such a way that good physical contact between shrink label and bottle is permanently ensured.

The shrink film should preferably shrink within the temperature range of about 50° C. to 90° C. by an amount of at least 5% in the direction of orientation and with sufficient force to provide a firmly attached, closely fitting skin around the bottle which is enclosed within the wrapping.

The shrink film preferably has a thickness of between 5 μm and 100 μm, particularly preferably between 7.5 μm and 75 μm and more particularly preferably between 10 μm and 60 μm. The shrink film can [be] for example a co-extruded film, a stretch wrap or stretch film, an extruded film, a flat film, a stretched or oriented film, a cast film, a calendared film or a foam film.

It is preferred to arrange the shrink film so that it fits around the bottle in one layer.

The material from which the shrink film is made should exhibit good printability. In particular, the shrink film can be printed and it is particularly preferred for the shrink film to be printed over its entire surface.

It is furthermore preferred for the shrink film to be printed substantially over its entire surface and thus to be substantially opaque in form, as a result of which it forms an appropriately good UV barrier, which protects the contents of the bottle against UV radiation from the environment. This is of particular advantage in the case of packaged products having UV-sensitive ingredients, such as enzymes, vitamins, dyes or scents etc.

The shrink film can also contain special UV barrier substances. These can be of particular advantage in order to protect a UV-sensitive packaged product in the event that transparent viewing windows or viewing areas are used.

In principle, it is also possible to use so-called stretch films for the invention, which may also be classified as shrink film within the meaning of the present application. A stretch film is understood to be a film with an adhesive tendency, which can be fitted closely around the packaging means when stretched manually or mechanically. In this case, the stretch film and the bottle are configured in such a way that good physical contact between the stretch film and the bottle is permanently ensured. The stretch film should preferably be made of stretchable materials and should contract with sufficient force to provide a firmly attached, closely fitting skin around the packaging means enclosed within the wrapping.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

What is claimed is:

1. A method for producing a bottle having a sheath made of a shrinkable plastic film, wherein the bottle comprises on the circumferential surface thereof at least one grip recess or handle opening projecting into the interior of the bottle,
comprising the following steps:
producing a tube from the shrinkable plastic film,
drawing the tube onto the bottle,
shrink-fitting the plastic film onto the bottle,
laser-cutting the area of the shrinkable plastic film which covers the grip recess or handle opening of the bottle,
sucking away the cut-out area by means of a blower.

2. The method according to claim 1, wherein the shrink film has a thickness of between 5 μm and 100 μm.

3. The method according to claim 1, wherein the shrink film shrinks by an amount of at least 5% in the direction of orientation within the temperature range from about 50° C. to 90° C.

4. The method according to claim 1, wherein the laser-cutting is performed using a 60 W CO2 laser.

5. A bottle having a sheath made of a plastic film shrink-fitted onto the circumferential surface of the bottle, wherein the bottle comprises on the circumferential surface thereof at least one indentation or opening projecting into the interior of the bottle and wherein the area of the shrink-fitted plastic film, which encloses the grip recess or opening of the bottle, is produced by means of laser-cutting, particularly by the method of claim 1.
